(19) United States
(12) Patent Application Publication
(10) Pub. No.: US 2024/0234011 A9
(43) Pub. Date: Jul. 11, 2024

(54) Magnetic-Shielding-and-Enhancement Winding

(71) Applicant: WiTricity Corporation, Watertown, MA (US)

(72) Inventor: Kylee Devro Sealy, Providence, UT (US)

(73) Assignee: WiTricity Corporation, Watertown, MA (US)

(21) Appl. No.: 18/457,818

(22) Filed: Aug. 29, 2023

Related U.S. Application Data
(60) Provisional application No. 63/380,671, filed on Oct. 24, 2022.

(51) Int. Cl. H01F 27/28; H02J 50/10; H02J 50/70

(52) U.S. Cl. CPC H01F 27/2885; H02J 50/10; H02J 50/70

(57) ABSTRACT

Techniques for a magnetic-shielding-and-enhancement winding are disclosed. The magnetic-shielding-and-enhancement winding is a winding of a multi-turn coil that is on a separate layer from other windings of the coil (e.g., on a general winding layer). The magnetic-shielding-and-enhancement winding provides magnetic shielding to reduce localized multiplicative effects of aggregate fields generated by the windings of the coil on the general winding layer and simultaneously acts as one or more turns of the winding structure to enhance the field in a desirable manner.

### PRIORITY CLAIM AND CROSS-REFERENCE TO RELATED APPLICATIONS

This application claims priority to U.S. Provisional Patent Application No. 63/380,671, filed Oct. 24, 2022, the content of which is hereby incorporated by reference in its entirety.

### FIELD

This application is generally related to wireless power transfer applications, and specifically to a magnetic-shielding-and-enhancement winding that reduces localized fields to shield electronics integrated into a coil.

### BACKGROUND

In some circumstances, it is desirable to reduce extremely localized fields from multiple coil windings to reduce localized fields within ferrite used behind a coil and thus reduce localized losses while maintaining an average field. In some cases, it is desirable to utilize a coil without ferrite and include electronics (e.g., integrated circuit (IC) components) disposed on a printed circuit board shared with the coil, while having the electronics shielded from a high localized field caused by the proximity of multiple windings. It may also be desirable to reduce the effect on the reactance of the coil from other ferrous or metallic objects, including another coil.

In some scenarios, it may be desirable to control the effective parallel capacitance caused by at least one of the coil windings to set or adjust the self-resonance of the coil. When setting or adjusting the self-resonance of the coil, it may be desirable to decrease the effective parallel capacitance dissipation factor and increase the self-resonance quality factor for a resultant resonator. Adjusting the self-resonance in either direction (e.g., increase or decrease) can be useful in different implementations such as, for example, to increase the self-resonant frequency away from an operating frequency of the coil to get a higher quality factor for the coil or, alternatively, to decrease the self-resonant frequency toward self-resonance of the coil. In addition, it may be desirable in some implementations to reduce the number of diodes required for rectification, produce a balanced design for electromagnetic interference (EMI) purposes, and/or more effectively use the area of a printed circuit board (PCB) for both a coil and electronic components without greatly affecting the properties of the coil.

These challenges require non-trivial solutions, which are not provided by existing coil topologies. Accordingly, conventional wireless power transfer systems are less efficient without these capabilities.

### SUMMARY

Techniques for a magnetic-shielding-and-enhancement winding are disclosed. The magnetic-shielding-and-enhancement winding is a winding of a multi-turn coil that is on a separate layer from other windings of the coil (e.g., on a general winding layer). The magnetic-shielding-and-enhancement winding provides magnetic shielding to reduce localized multiplicative effects of aggregate fields generated by the windings of the coil on the general winding layer and simultaneously acts as one or more turns of the winding structure to enhance the field in a desirable manner.

One aspect of the disclosure provides a wireless-power-transfer unit comprising a coil wound to form an opening. The coil includes a first winding layer and a second winding layer. The first winding layer is in an xy-plane and has a plurality of windings that include at least an innermost winding and an outermost winding. The innermost winding is disposed between the opening and the outermost winding. The second winding layer is stacked in a z-direction with the first winding layer and has a magnetic-shielding-and-enhancement winding. The magnetic-shielding-and-enhancement winding is electrically connected to at least one winding of the plurality of windings in the first winding layer. The magnetic-shielding-and-enhancement winding also includes first and second opposing surfaces that are normal to the z-direction, where the first surface directly faces the first winding layer. In addition, the magnetic-shielding-and-enhancement winding is configured to shield one or more electronics disposed proximate to the second surface and provide a ground plane for the one or more electronics.

Various implementations of systems, methods, and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in accompanying drawings and the descriptions below. Other features, aspects, and advantages will become apparent from the description, the drawings, and the claims.

### BRIEF DESCRIPTION OF THE DRAWINGS

FIG. 1 is a functional block diagram of an example wireless power transfer system, in accordance with certain aspects of the present disclosure.

FIG. 2 is a more-detailed block diagram of an example wireless power transfer system, in accordance with aspects of the present disclosure.

FIG. 3 is a schematic diagram of a portion of the transmit circuitry or the receive circuitry of FIG. 2, in accordance with certain aspects of the present disclosure.

FIG. 4 illustrates an example implementation of a coil having a magnetic-shielding-and-enhancement winding.

FIG. 5A illustrates a simulation of surface magnetic flux density of a coil without the magnetic-shielding-and-enhancement winding.

FIG. 5B illustrates a simulation of the surface magnetic flux density of a coil with the magnetic-shielding-and-enhancement winding.

FIG. 6 illustrates an example implementation of a coil having a magnetic-shielding-and-enhancement winding shaped in a pattern.

FIG. 7 illustrates an example implementation of a coil having a magnetic-shielding-and-enhancement winding formed by a layer of patches.

FIG. 8 illustrates another example implementation of a coil having a magnetic-shielding-and-enhancement winding formed by a layer of patches.

FIG. 9 illustrates an example implementation of a coil having a magnetic-shielding-and-enhancement winding disposed on multiple layers of the coil.

FIG. 10 illustrates an example implementation of a coil having a magnetic-shielding-and-enhancement winding with a width that substantially matches a width of the coil windings.

FIG. 11 illustrates an example implementation of a coil having a magnetic-shielding-and-enhancement winding with a width that is significantly greater than the width of the coil windings.

FIG. 12 illustrates a simulation of the surface magnetic flux density of the coil from FIG. 11.

### DETAILED DESCRIPTION

Techniques for a magnetic-shielding-and-enhancement winding are disclosed herein. The magnetic-shielding-and-enhancement winding is used to reduce extremely localized fields from multiple coil windings in order to reduce localized fields within ferrite used behind a coil to reduce localized losses. Implementing the magnetic-shielding-and-enhancement winding described herein can further enable a coil to be utilized without ferrite but with electronics placed in strategic locations on the same PCB as the coil while magnetically shielding the electronics against high localized fields caused by proximity of multiple windings. Further, the magnetic-shielding-and-enhancement winding can reduce the effect on the reactance of the coil from other ferrous or metallic objects.

In some implementations, the magnetic-shielding-and-enhancement winding can be used to set or adjust the self-resonance of the coil to control the effective parallel capacitance caused by one winding to the other windings. In addition, the magnetic-shielding-and-enhancement winding can serve as a ground plane for the electronics, which may reduce the required number of diodes for rectification, produce a balanced design for EMI purposes, or more effectively use the area of a PCB for both the coil and the electronics without significantly affecting the properties of the coil.

The detailed description set forth below in connection with the appended drawings is intended as a description of example implementations and is not intended to represent the only implementations in which the techniques described herein may be practiced. The term “example” used throughout this description means “serving as an example, instance, or illustration,” and should not necessarily be construed as preferred or advantageous over other example implementations. The detailed description includes specific details for the purpose of providing a thorough understanding of the example implementations. In some instances, some devices are shown in block diagram form. Drawing elements that are common among the following figures may be identified using the same reference numerals.

### Example Systems

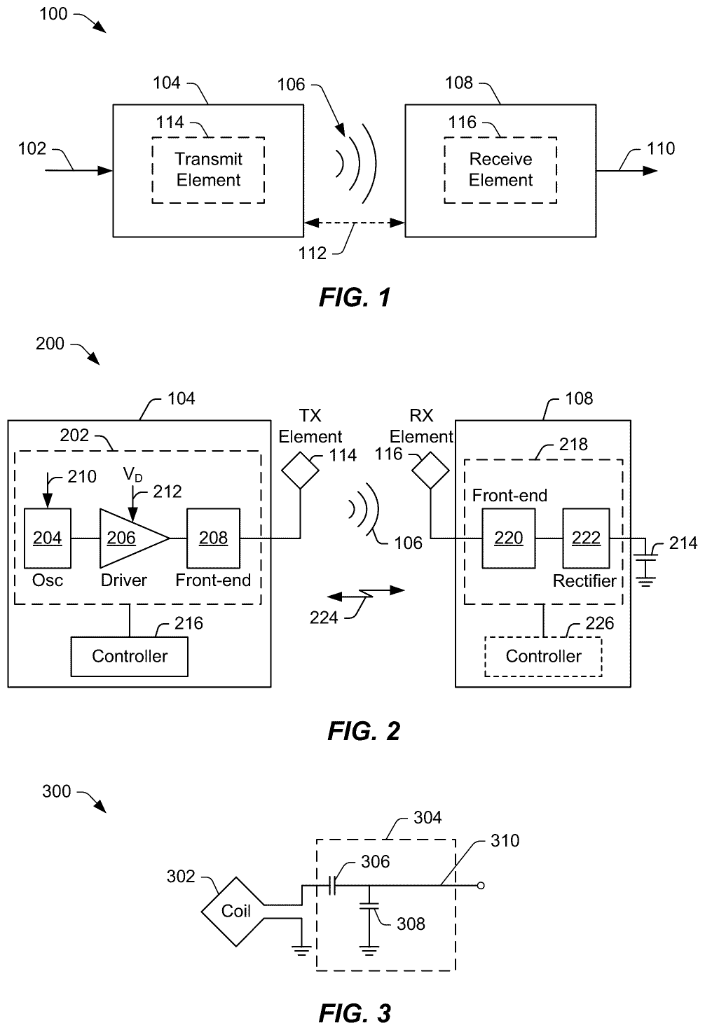

FIG. 1 is a functional block diagram of an example wireless power transfer system 100, in accordance with certain aspects of the present disclosure. Input power 102 may be provided to a transmitter 104 from a power source (not shown in this figure) to generate a wireless (e.g., magnetic or electromagnetic) field 106 for performing energy transfer. A receiver 108 may be subjected to the wireless field 106 and generate output power 110 for storing or consumption by a device (e.g., a battery) coupled to the output power 110. The transmitter 104 and the receiver 108 may be separated by a distance 112. The transmitter 104 may include a power transmitting element 114 for transmitting/providing energy to the receiver 108. The receiver 108 may include a power receiving element 116 for receiving/capturing energy transmitted from the transmitter 104.

In one illustrative aspect, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for increased efficiency and power transfer over various distances and with a variety of inductive power transmitting and receiving element configurations.

In some aspects, the wireless field 106 may correspond to a “near field” of the transmitter 104. The near field may correspond to a region in which there are strong reactive fields resulting from the currents and charges in the power transmitting element 114 that minimally radiate power away from the power transmitting element 114. The near field may correspond to a region that is within about one wavelength (or a fraction thereof, e.g., one wavelength divided by 27) of the power transmitting element 114. Conversely, a far field may correspond to a region that is greater than about one wavelength (or a fraction thereof, e.g., one wavelength divided by 27) of the power transmitting element 114.

In aspects, efficient energy transfer may occur by coupling a large portion of the energy in the wireless field 106 to the power receiving element 116, rather than propagating most of the energy in an electromagnetic wave to the far field.

In some implementations, the transmitter 104 may output a time-varying magnetic (or electromagnetic) field with a frequency corresponding to the resonant frequency of the power transmitting element 114. When the receiver 108 is within the wireless field 106, the time-varying magnetic (or electromagnetic) field may induce a current in the power receiving element 116. As described above, if the power receiving element 116 is configured as a resonant circuit to resonate at (or very close to) the frequency of the power transmitting element 114, energy may be efficiently transferred. An alternating current (AC) signal induced in the power receiving element 116 may be rectified to produce a direct current (DC) signal that may be provided to charge or to power a load (e.g., a battery).

FIG. 2 is a more-detailed block diagram of an example wireless power transfer system 200, in accordance with aspects of the present disclosure. The system 200 may include the transmitter 104 and the receiver 108. The transmitter 104 (also referred to herein as a power-transmit unit, or PTU) includes transmit circuitry 202 that may include an oscillator 204, a driver circuit 206, and a front-end circuit 208. The oscillator 204 may be configured to generate an oscillator signal (also known as an oscillating signal) at a desired frequency (e.g., fundamental frequency), which may be adjusted in response to a frequency control signal 210. The oscillator 204 may provide the oscillator signal to the driver circuit 206. The driver circuit 206 may be configured to drive the power transmitting element 114 at, for example, a resonant frequency of the power transmitting element 114, according to the frequency of the oscillator signal. The power transmitting element 114 may be powered by a power supply signal (V_{D}) 212. The driver circuit 206 may be a switching amplifier configured to receive a square wave from the oscillator 204 and output a sine wave as a driving signal output.

The front-end circuit 208 may include a filter circuit configured to filter out harmonics or other unwanted frequencies. The front-end circuit 208 may also include a matching circuit configured to match the impedance of the transmitter 104 to the impedance of the power transmitting element 114 in an effort to reduce power loss. As explained in more detail below, the front-end circuit 208 may include a tuning circuit to create a resonant circuit with the power transmitting element 114. As a result of driving the power transmitting element 114, the power transmitting element 114 may generate the wireless field 106 to wirelessly output power at a level sufficient for charging a battery 214, or otherwise powering a load.

The transmitter 104 may further include a controller 216 operably coupled to the transmit circuitry 202 and configured to control one or more aspects of the transmit circuitry 202, or accomplish other operations relevant to managing the transfer of power. The controller 216 may be a microcontroller or a processor, for example. In some aspects, the controller 216 may be implemented as an application-specific integrated circuit (ASIC). The controller 216 may be operably connected, directly or indirectly, to each component of the transmit circuitry 202. The controller 216 may be further configured to receive information from each of the components of the transmit circuitry 202 and perform calculations based on the received information. The controller 216 may be configured to generate control signals (e.g., signal 210) for each of the components that may adjust the operation of that component. As such, the controller 216 may be configured to adjust or manage the power transfer based on a result of the operations performed by it. The transmitter 104 may further include a memory (not shown) configured to store data, such as instructions for causing the controller 216 to perform particular functions, such as those related to management of wireless power transfer.

The receiver 108 (also referred to herein as a power-receive unit, or PRU) includes receive circuitry 218 that may include a front-end circuit 220 and a rectifier circuit 222. The front-end circuit 220 may include matching circuitry configured to match the impedance of the receive circuitry 218 to the impedance of the power receiving element 116 in an effort to reduce power loss. As will be explained below, the front-end circuit 220 may further include a tuning circuit to create a resonant circuit with the power receiving element 116. The rectifier circuit 222 may generate a DC power output from an AC power input to charge the battery 214, as shown in FIG. 2, or power a load. The receiver 108 and the transmitter 104 may additionally communicate on a separate communication channel 224 using any suitable radio access technology (e.g., Bluetooth, Zigbee, cellular, etc.). The receiver 108 and the transmitter 104 may alternatively communicate via in-band signaling using characteristics of the wireless field 106.

The receiver 108 may be configured to determine whether an amount of power transmitted by the transmitter 104 and received by the receiver 108 is appropriate for charging the battery 214. In some aspects, the transmitter 104 may be configured to generate a predominantly non-radiative field with a direct field coupling coefficient (k) for providing energy transfer. Receiver 108 may directly couple to the wireless field 106 and may generate an output power for storing or consumption by a battery 214 (or load) coupled to the output or receive circuitry 218.

The receiver 108 may further include a controller 226 configured similarly to the transmit controller 216 as described above for managing one or more aspects of the receiver 108. The receiver 108 may further include a memory (not shown) configured to store data, such as instructions for causing the controller 226 to perform particular functions, such as those related to management of wireless power transfer.

As discussed above, the transmitter 104 and the receiver 108 may be separated by a distance and may be configured according to a mutual resonant relationship to minimize transmission losses between the transmitter 104 and the receiver 108.

FIG. 3 is a schematic diagram of a portion of the transmit circuitry 202 or the receive circuitry 218 of FIG. 2, in accordance with certain aspects of the present disclosure. As illustrated in FIG. 3, transmit or receive circuitry 300 may include a power transmitting or receiving element 302 and a tuning circuit 304. The power transmitting or receiving element 302 may also be referred to or be configured as an antenna or a “loop” antenna. The term “antenna” generally refers to a component that may wirelessly output or receive energy for coupling to another antenna. The power transmitting or receiving element 302 may also be referred to herein or be configured as a “magnetic” antenna, an induction coil, an inductive coil, a resonator, or a portion of a resonator. The power transmitting or receiving element 302 may also be referred to as a coil or resonator of a type that is configured to wirelessly output or receive power. As used herein, the power transmitting or receiving element 302 is an example of a “power transfer component” of a type that is configured to wirelessly output and/or receive power. The power transmitting or receiving element 302 may include an air core or a physical core such as a ferrite core (not shown FIG. 3).

When the power transmitting or receiving element 302 is configured as a resonant circuit or resonator with tuning circuit 304, the resonant frequency of the power transmitting or receiving element 302 may be based on the inductance and capacitance. Inductance may be simply the inductance created by a coil and/or other inductor forming the power transmitting or receiving element 302. Capacitance (e.g., a capacitor) may be provided by the tuning circuit 304 to create a resonant structure at a desired resonant frequency. As a non-limiting example, the tuning circuit 304 may comprise a capacitor 306 and a capacitor 308, which may be added to the transmit and/or receive circuitry 300 to create a resonant circuit.

The tuning circuit 304 may include other components to form a resonant circuit with the power transmitting or receiving element 302. As another non-limiting example, the tuning circuit 304 may include a capacitor (not shown) placed in parallel between the two terminals of the circuitry 300. Still other designs are possible. In some aspects, the tuning circuit in the front-end circuit 208 of the transmitter 104 may have the same design (e.g., 304) as the tuning circuit in front-end circuit 220 of the receiver 108. In other aspects, the front-end circuit 208 of the transmitter 104 may use a tuning circuit design different from the front-end circuit 220 of the receiver 108.

For power transmitting elements, a signal 310, with a frequency that substantially corresponds to the resonant frequency of the power transmitting or receiving element 302, may be an input to the power transmitting or receiving element 302. For power receiving elements, the signal 310, with a frequency that substantially corresponds to the resonant frequency of the power transmitting or receiving element 302, may be an output from the power transmitting or receiving element 302. Although aspects disclosed herein may be generally directed to resonant wireless power transfer, persons of ordinary skill in the art will appreciate that aspects disclosed herein may be used in non-resonant implementations for wireless power transfer.

In some aspects, when power is wirelessly received by a device (e.g., an electric vehicle, a remote switch) with a wireless power receiver (e.g., receiver 108) from a wireless power transmitter (e.g., transmitter 104), there may be a method of power control to ensure that the correct amount of power is transferred from the transmitter 104 to the receiver 108. For example, the device with the receiver 108 may be configured to operate or charge at a particular voltage (e.g., 4.2 V). However, generating a fixed strength wireless field (e.g., wireless field 106) by the transmitter 104 may not produce the desired voltage at the receiver 108. For example, the amount of power transferred between the transmitter 104 and the receiver 108 at any given strength of the wireless field 106 may differ based on the distance between (and/or other factors such as materials between, etc.) the transmitter 104 and the receiver 108. Accordingly, the power generated by the receiver 108 for the device may be variable based on one or more factors for the same strength of wireless field 106 from the transmitter 104.

In some aspects, a closed-loop power control scheme may be employed to adjust the strength of the wireless field 106 to ensure that the power (e.g., voltage) at the device being wirelessly powered is the desired power (e.g., desired voltage). For example, in some aspects, the receiver 108 may be configured to actively determine a power level of the power received at the receiver 108, such as, a voltage at the rectifier circuit 222. For example, the controller 226 may be configured to monitor the voltage at the rectifier circuit 222. Depending on whether the voltage at the rectifier circuit 222 is above or below a range of the desired voltage level, the receiver 108 (e.g., as controlled by the controller 226) may transmit feedback information (e.g., as a control signal) (e.g., via communication channel 224 or in-band signaling using the wireless field 106) to the transmitter 104 indicating whether a strength of the wireless field 106 should be increased or decreased. No control signal may be sent if the voltage at the rectifier circuit 222 is within the range of the desired voltage level. The transmitter 104 may receive the control signal and adjust the strength of the wireless field 106 (e.g., by control from the controller 216), accordingly.

### Example Implementations

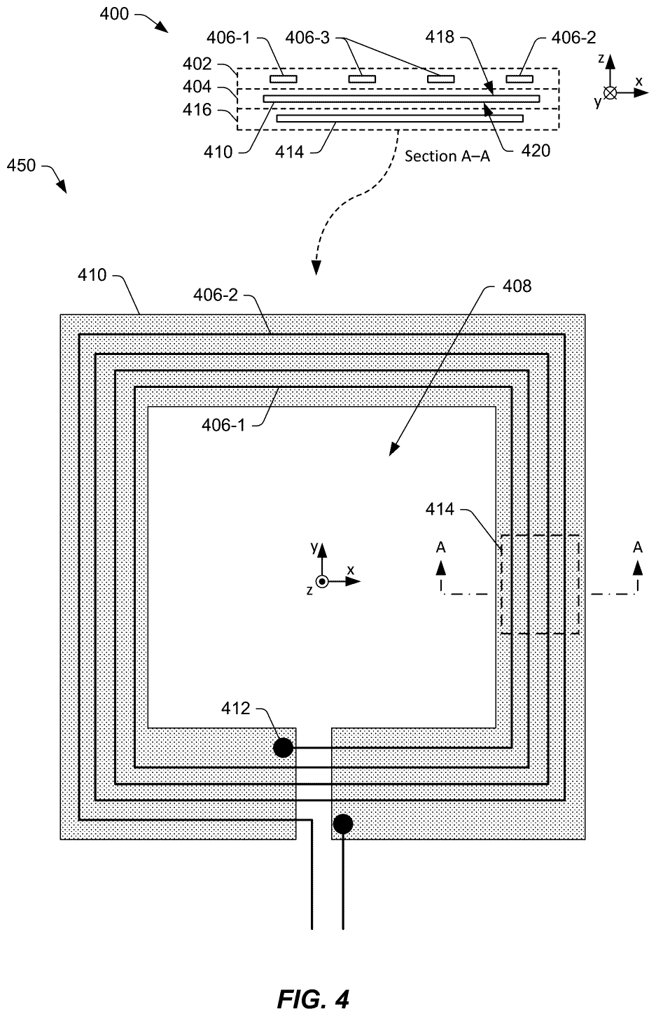

FIG. 4 illustrates an example implementation of a coil (e.g., power transmitting or receiving element 302, power transmitting element 114, power receiving element 116) having a magnetic-shielding-and-enhancement winding. In FIG. 4, the coil is illustrated in a top plan view 400 and a two-dimensional (2D) cross section view 450 taken at line A-A. For simplicity, the illustrated example includes a first winding layer 402 and a second winding layer 404. The first winding layer 402 is separate from the second winding layer 404. The first winding layer 402 includes multiple turns or windings 406 of a coil (e.g., conductive traces, Litz wires) wound to form an opening (e.g., opening 408). Litz wire may be formed on a PCB as described in U.S. Pat. No. 8,716,903, titled Low AC Resistance Conductor Designs, the entire contents of which are incorporated here by reference. In aspects, the opening 408 is located in the center of the coil. The first winding layer 402 includes at least an innermost winding 406-1 and an outermost winding 406-2. In some implementations, the first winding layer 402 also includes one or more middle windings 406-3. The second winding layer 404 may be a last layer in the stack (e.g., in the z-direction). Alternatively, the second winding layer 404 may be the first layer in the stack. In addition, the second winding layer 404 may be any of the turns of the coil (e.g., connected to one or more of the windings 406 but remaining in the second winding layer 404). For example, the second winding layer 404 may be connected to the innermost winding 406-1, thereby acting as a first winding of the coil. In another example, the second winding layer 404 may be connected to the outermost winding 406-2 and thus act as a last winding of the coil. In yet another example, the second winding layer 404 may be a center winding (e.g., winding 3 of 5 turns, winding 4 of 7 turns, winding 5 of 9 turns) or a center layer in the stack.

The first winding layer 402 and the second winding layer 404 may be included in a multi-layer PCB (e.g., 2-layer board, 3-layer board, 4-layer board). Accordingly, additional layers may be incorporated into the stack. In some aspects, such additional layers include windings similar to the first winding layer 402. A distance between the first and second winding layers 402 and 404 (in the z-direction) can be set according to a desired self-resonant frequency of the coil.

The second winding layer 404 is a magnetic-shielding-and-enhancement winding 410, formed by one or more sheets of conductive material. In some implementations, the same conductive material is used for both the first winding layer 402 and the second winding layer 404. For example, the coil windings (e.g., traces, wires) may be the same material as the magnetic-shielding-and-enhancement winding 410 (e.g., copper, copper plated, or exotic material having low-eddy-current effects). In some implementations, however, the first winding layer 402 and the second winding layer 404 may be different materials relative to one another.

In one example, as illustrated, the innermost winding 406-1 of the first winding layer 402 connects to the second winding layer 404 at node 412 to make the magnetic-shielding-and-enhancement winding 410 the first turn of the coil. In another example, the magnetic-shielding-and-enhancement winding 410 may connect to the outermost winding 406-2 to be the last turn of the coil, or one or more of the middle windings 406-3 to be a middle turn in the coil.

Electronics (e.g., electronics 414) may be disposed behind or under (in the z-direction) the magnetic-shielding-and-enhancement winding 410, such as on a third layer 416 that is adjacent to the second winding layer 404, where the second winding layer 404 is between the first winding layer 402 and the third layer 416. The magnetic-shielding-and-enhancement winding 410 includes a first surface 418 and a second surface 420 opposite the first surface. In aspects, the first and second surfaces 418 and 420 are normal to the z-direction. Also, the first surface 418 directly faces the first winding layer 402. Electronics 414 can be disposed proximate or adjacent to the second surface 420, such that the magnetic-shielding-and-enhancement winding 410 is between the windings 406 and the electronics 414. In some implementations, a ferrite layer (not shown in FIG. 4) can be stacked under the electronics 414, such that the electronics 414 are between the ferrite and the magnetic-shielding-and-enhancement winding 410. Such a configuration reduces aggregated localized fields generated by the windings 406. In addition, some implementations omit the electronics and place the ferrite layer adjacent to the magnetic-shielding-and-enhancement winding to reduce the aggregated localized fields into the ferrite.

The magnetic-shielding-and-enhancement winding 410 reduces a localized multiplicative effect of aggregate fields from the multi-turn windings (e.g., windings 406) on a general winding layer (e.g., the first winding layer 402). In some implementations, such as when the magnetic-shielding-and-enhancement winding 410 is balanced (e.g., used as the center winding), a ground for the electronics can be tied directly to the magnetic-shielding-and-enhancement winding 410. In such an implementation, the magnetic-shielding-and-enhancement winding 410 is used as a ground plane for the electronics. Additionally, the magnetic-shielding-and-enhancement winding 410 can help reduce common-mode currents when using balanced matching that is center-tapped to the middle winding that is the magnetic-shielding-and-enhancement winding 410.

The magnetic-shielding-and-enhancement winding 410 may cause an increase in the interwinding capacitance of the coil, which may decrease the self-resonance of the coil, depending on the use-case and the quality factor of the resultant interwinding capacitance. In some implementations, a discrete capacitor can be disposed within the magnetic-shielding-and-enhancement winding 410 to increase the overall quality factor of the coil and/or the resonator by shifting the self-resonant frequency of the coil up. Including a discrete capacitor in the magnetic-shielding-and-enhancement winding 410 in this way may be useful particularly when the magnetic-shielding-and-enhancement winding 410 is the center winding of the coil.

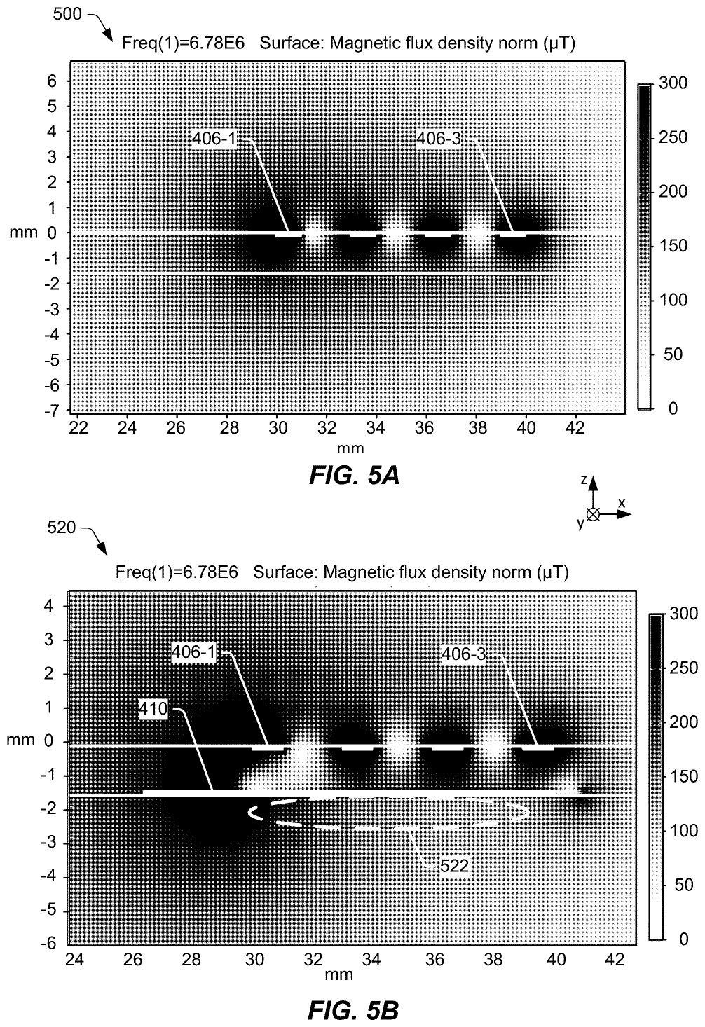

FIGS. 5A and 5B together provide a comparison showing the effect of the magnetic-shielding-and-enhancement winding 410 from FIG. 4 in the coil. In particular, FIG. 5A illustrates a simulation 500 of the surface magnetic flux density of a coil without the magnetic-shielding-and-enhancement winding from FIG. 4, whereas FIG. 5B illustrates a simulation 520 of the surface magnetic flux density of a coil with the magnetic-shielding-and-enhancement winding from FIG. 4. These simulations provide a cross section of four turns, which are typical wires in the 2D plane (e.g., xz-plane or yz-plane) and the wires are connected in series. The innermost winding 406-1 is on the left side of the images and the outermost winding 406-3 is on the right of the images.

The flux density in FIG. 5A is a fairly uniform field across the windings, with a slight increase toward the innermost winding 406-1. By comparison, the field shown in FIG. 5B is pushed toward the innermost winding 406-1, resulting in a stronger flux density proximate to the innermost winding 406-1. In this way, the magnetic-shielding-and-enhancement winding 410 enhances the field. The magnetic-shielding-and-enhancement winding 410 also acts as a shield. For example, directly behind (e.g., under) the magnetic-shielding-and-enhancement winding 410 (e.g., on an opposing side of the magnetic-shielding-and-enhancement winding 410 from the windings 406), there exists a small region 522 where the z-component of the field is significantly less. For example, in FIG. 5A, which is unshielded, the average magnitude of the h-field z-component at distance −2 mm (y-axis) from 34 mm to 40 mm (x-axis) is approximately 32.5 microtesla (μT). In contrast to the unshielded windings in FIG. 5A, the shielded windings in FIG. 5B have an average magnitude of the h-field z-component at distance −2 mm (y-axis) from 34 mm to 40 mm (x-axis) of approximately 3.5 μT. Accordingly, by implementing the shield in this way, the average magnitude of the h-field z-component is reduced by about 90%. Because of the reduction in the h-field, the small region 522 can be used for placement of electronics due to the reduced amount of flux density in that region 522.

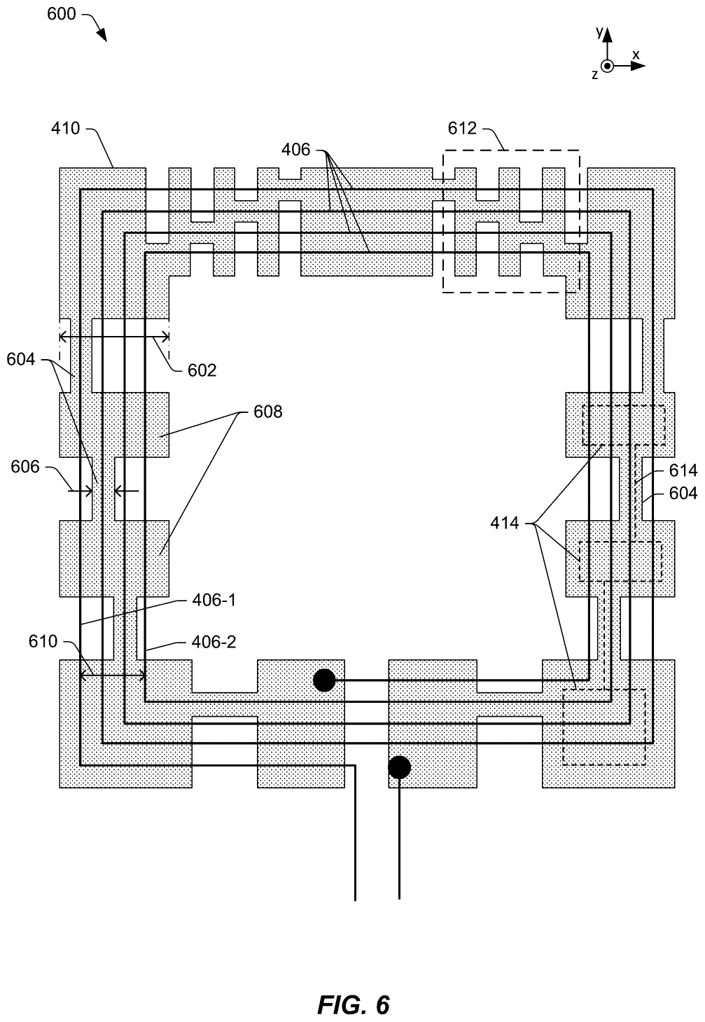

FIG. 6 illustrates an example implementation 600 of a coil having a magnetic-shielding-and-enhancement winding 410 shaped in a pattern. Various patterns can be used to control the overall inter-winding capacitance of the coil. For example, a width 602 of the magnetic-shielding-and-enhancement winding 410 can be reduced in certain sections (e.g., areas 604) to a reduced width 606, creating patches (e.g., patches 608) where electronics can be placed. Accordingly, at least some of the areas 604 with the reduced width 606 connect two patches 608. In this case, the width of the patches 608 may be referred to as a patch width. Further, a width of the windings 406 may be referred to as a winding width 610 and is defined from the innermost winding 406-1 to the outermost winding 406-2. As illustrated, the reduced width 606 is less than the winding width 610, whereas the patch width (e.g., width 602) is greater than the winding width 610.

The pattern can be varied to balance the capacitance between the magnetic-shielding-and-enhancement winding 410 and each of the other windings 406. In some aspects, the pattern includes a zigzag pattern 612 and/or a looping pattern without patches to maintain equal capacitance between each of the windings 406 and the magnetic-shielding-and-enhancement winding 410.

Various patterns can be used to maintain connection all the way around the coil loops but shift which winding 406 the connection is relative to. In this way, the inter-winding capacitance remains balanced across all the winding components but the amount of area of the magnetic-shielding-and-enhancement winding 410 is reduced (e.g., minimized), and hence the amount of capacitance is reduced (e.g., minimized), which increases the self-resonance of the coil. In the illustrated example, electronics (e.g., electronics 414) may be placed behind the patches 608 and inter-routing 614 of the electronics may be placed directly behind a portion 616 (e.g., area 604) of the magnetic-shielding-and-enhancement winding 410 having the reduced width.

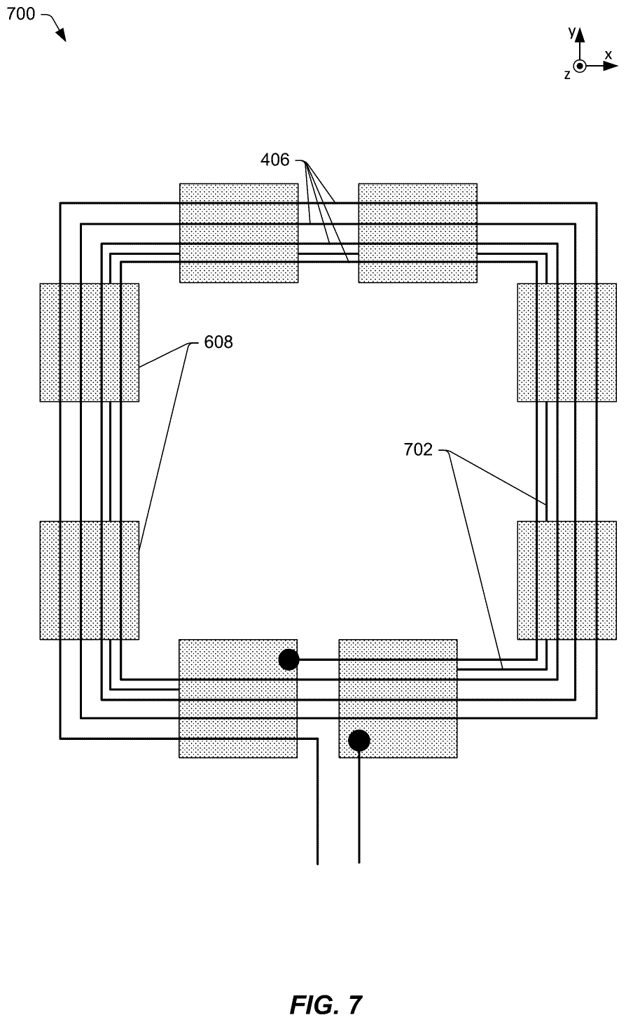

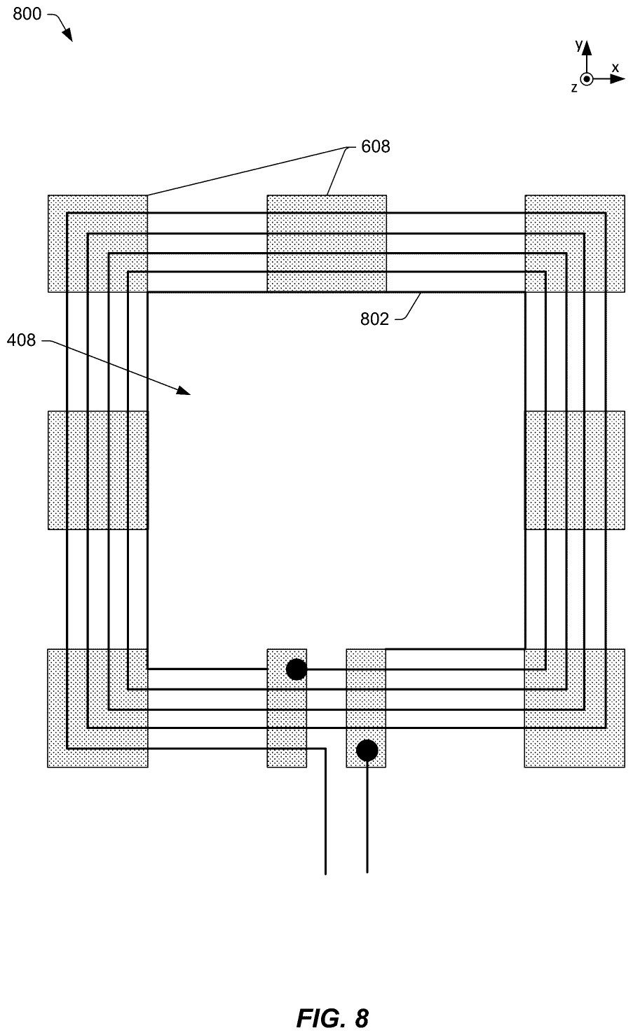

FIG. 7 illustrates an example implementation 700 of a coil having a magnetic-shielding-and-enhancement winding 410 formed by a layer of patches. In this example, the second winding layer 404 includes a plurality of patches 608 connected by thin connection line 702, which may be a typical winding (e.g., similar to winding 406). In aspects, the connection line 702 is in the same layer as the patches 608 (e.g., in the second winding layer 404). In this way, the winding continues normally between the patches within the second winding layer 404. Although the patches 608 are illustrated as having rectangular shapes, the patches 608 may have any suitable shape (e.g., spiral, rounded rectangle, square, elliptical, circular). Also, the first winding layer 402 (including the windings 406) may also have any suitable shape (e.g., spiral, rounded rectangle, square, elliptical, circular) but, for purposes of discussion and simplicity, the first winding layer 402 is illustrated as having a rectangular shape.

FIG. 8 illustrates another example implementation 800 of a coil having a magnetic-shielding-and-enhancement winding 410 formed by a layer of patches. In this example, the patches 608 in the second winding layer 404 are connected by a thin connection (e.g., connection 802) in the second winding layer 404. In this way, the connection 802 forms an innermost winding of the coil but in the second winding layer 404, which helps to push the field toward the opening 408 in regions between the patches 608.

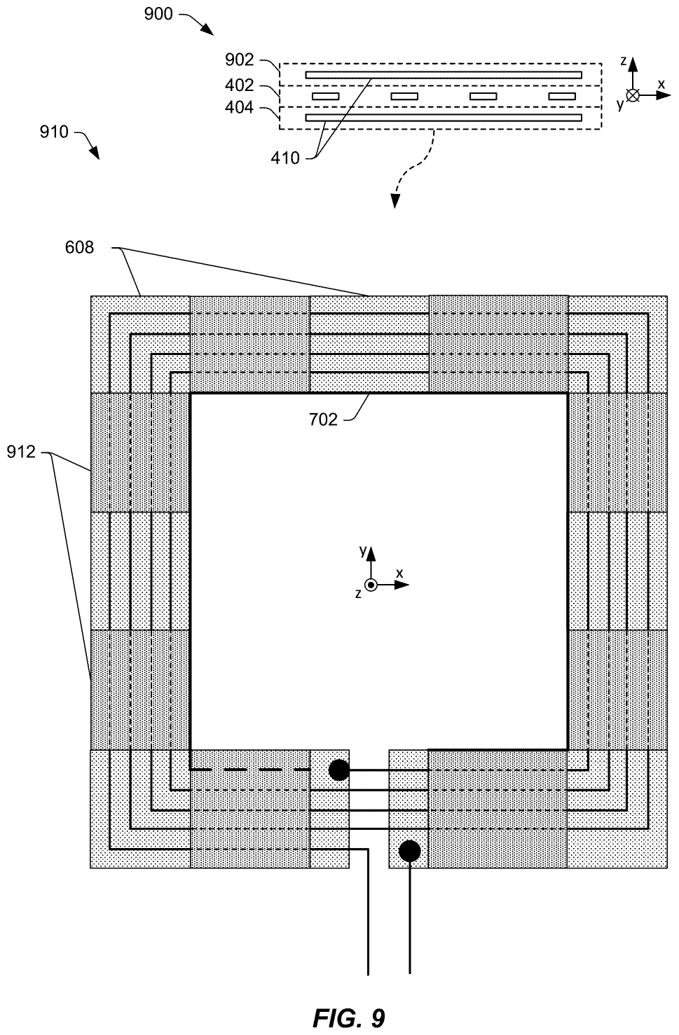

FIG. 9 illustrates an example implementation of a coil having a magnetic-shielding-and-enhancement winding 410 disposed on multiple layers of the coil. In FIG. 9, a simplified 2D cross section 900 of the example coil is illustrated as including three stacked layers. A corresponding top plan view 910 of the example coil is also illustrated. In this example, the magnetic-shielding-and-enhancement winding 410 is located on multiple layers of the stack, such as the top layer and the bottom layer, with the other windings in between. Although three layers are shown, any suitable number of layers can be included in the stack, including 4 layers, 5 layers, 6 layers, and so forth.

By implementing the magnetic-shielding-and-enhancement winding 410 on opposing sides (in the z-direction) of the other windings 406, electronics can be placed on both sides of the coil (e.g., on fourth and fifth layers that are above and below, respectively, the coil stack) and be shielded by the magnetic-shielding-and-enhancement winding 410. Additionally, using the magnetic-shielding-and-enhancement winding 410 to sandwich the other windings 406 can help increase the interwinding capacitance or reduce extremely localized fields on both sides of the coil (e.g., ferrite on one side and impact of ferrite to another coil in proximity to the other side). In some implementations, the electronics may be placed on one side of the coil and ferrite may be placed on the opposite side of the coil, or any combination thereof. In another example, ferrite is disposed on both sides of the coil (e.g., on fourth and fifth layers that are above and below, respectively, the coil stack), which may cause the coil to become an effective inductor where the localized fields are more distributed to the center of the coil, thus creating an effective shielded inductor. When ferrite is disposed on both sides of the coil, the magnetic-shielding-and-enhancement winding 410 may be used to direct the flux to specific areas of the ferrite (where the ferrite may be thicker or less lossy) or to enable less ferrite to be used.

In one example, the magnetic-shielding-and-enhancement winding 410 provided on opposing sides of the other windings 406 can essentially encapsulate those windings 406, such that the entire coil is shielded on both sides. In this way, with ferrite on one side of the coil, proximity to other metal objects has a negligible effect on the self-inductance of the coil. In some implementations, the two layers of the magnetic-shielding-and-enhancement winding 410 are separate windings that individually shield the other windings 406. In other implementations, the two layers of the magnetic-shielding-and-enhancement winding 410 are connected together to form a single winding. Any suitable pattern, including those described with respect to FIGS. 6-8, can be used in either or both layers of the magnetic-shielding-and-enhancement winding 410.

The illustrated example shows a simplified coil stack in which the first winding layer 402 is disposed between the second winding layer 404 and a third winding layer 902, where the second winding layer 404 and the third winding layer 902 are layers of the magnetic-shielding-and-enhancement winding 410. The second winding layer 404 includes patches 608, which are connected together within the second winding layer 404, similar to that described above with respect to FIGS. 6-8. Similarly, the third winding layer 902 includes patches 912, which are connected together within the third winding layer 902 on an opposing side of the windings 406 from the patches 608 in the second winding layer 404. In the illustrated example, the windings 406 are depicted as dashed lines where the windings 406 are located behind the patches 912 in the view 910. Further, the patches 608 and 912 may create an alternating pattern around the coil. For example, in the y-direction (e.g., left or right side of the top plan view 910) the patches 912 are between the patches 608, and vice versa. In this way, the magnetic-shielding-and-enhancement winding(s) provide shielding in an alternating pattern that switches from top to bottom (z-direction) of the coil. The patches 912 in the third winding layer 902 may overlap (in the z-direction) the patches 608 in the second winding layer 404.

In one example, one or more of the patches 608 in the second winding layer 404 are connected (e.g., via connection line 702) to one or more of the patches 912 in the third winding layer 902 to create a single magnetic-shielding-and-enhancement winding 410 that is on opposing sides of the other windings 406. In another example, the patches 608 in the second winding layer 404 are connected (e.g., via connection line 702) to each other and not to the patches 912 in the third winding layer 902, which are connected to each other, thereby creating two separate windings that individually shield the other windings 406. In some implementations, the pattern in the second winding layer 404 may be different from the pattern in the third winding layer 902.

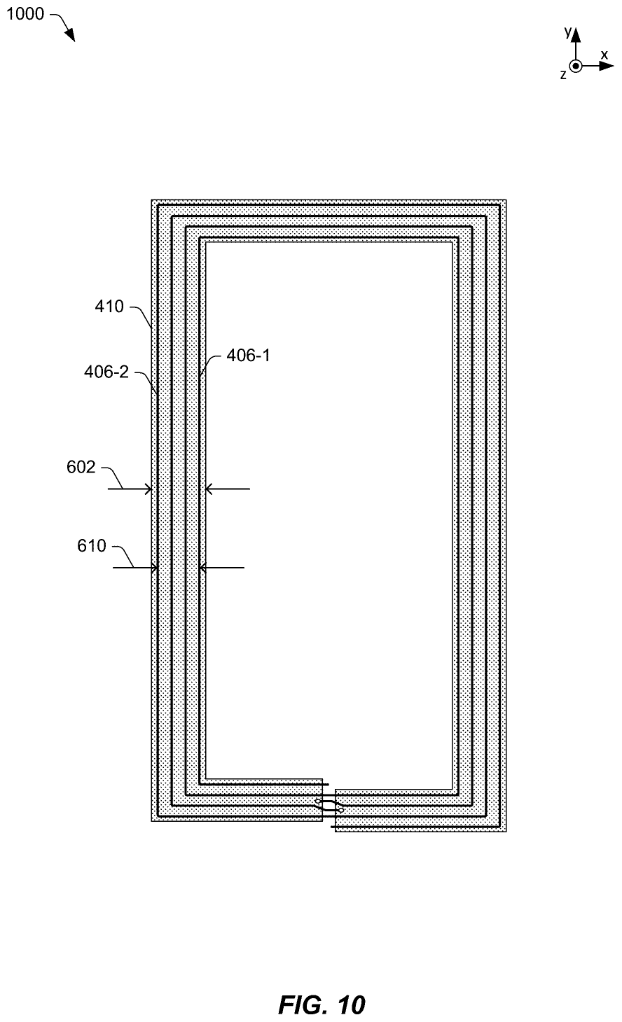

FIG. 10 illustrates an example implementation 1000 of a coil having a magnetic-shielding-and-enhancement winding with a width that substantially matches a width of the coil windings. For example, the magnetic-shielding-and-enhancement winding 410 has a width 602 that is substantially equal to (e.g., within a range of about one millimeter) the winding width 610 of the coil windings (e.g., distance from the innermost winding 406-1 to the outermost winding 406-2). This implementation 1000 may be referred to as a narrow magnetic-shielding winding and corresponds to the simulation of the surface magnetic flux density of the coil shown in FIG. 5B. This narrow magnetic-shielding winding provides shielding primarily in the z-direction (e.g., through the PCB). In aspects, the narrow magnetic-shielding winding is utilized as a center-tap, which enables the narrow magnetic-shielding winding to be used as a ground plane for electronics and reduces the number of required diodes for full-wave rectification.

In the illustrated example, the tangential components of the field (e.g., x- and y-components) are not significantly reduced but a z-component of the field is substantially reduced (e.g., z-component of the h-field in the region 522 may be reduced by about 90%, as described with respect to FIG. 5B). This may be useful even though the overall magnitude of the field is similar to what it would be without the magnetic-shielding winding. For example, even if the electronics are not sensitive to the field, the magnetic-shielding winding can still be used as a ground plane, which enables the use of simpler rectification and inclusion of the electronics on the same board (e.g., PCB) as the coil.

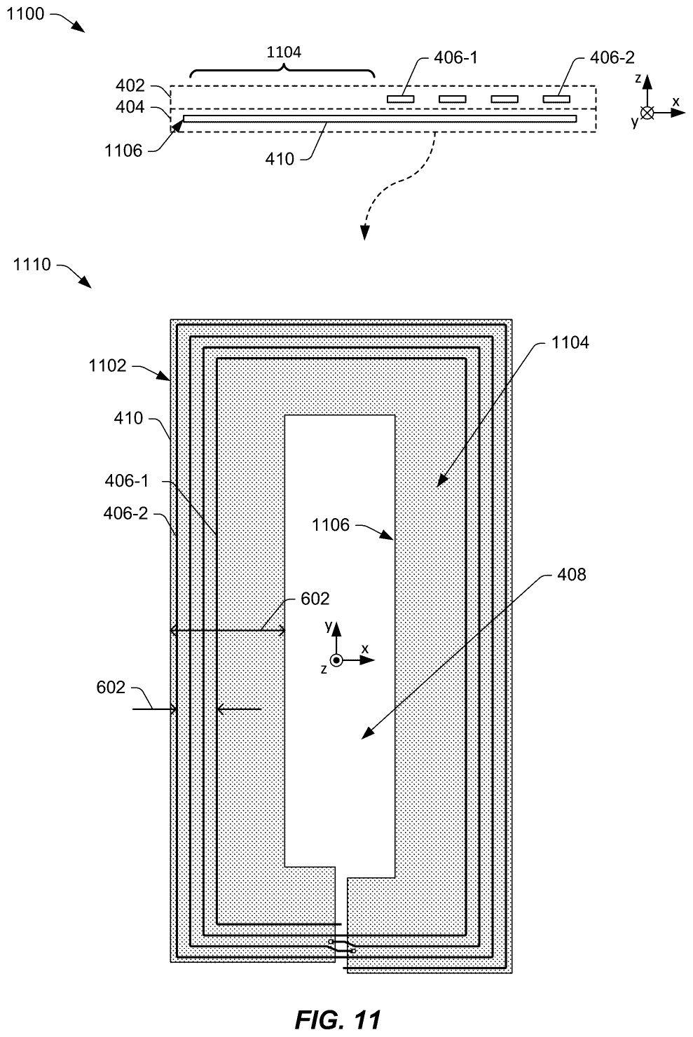

FIG. 11 illustrates an example implementation of a coil having a magnetic-shielding-and-enhancement winding 410 with a width that is significantly greater than the width of the coil windings. FIG. 11 includes a simplified 2D cross section 1100 of the example coil having two winding layers (e.g., the first winding layer 402 and the second winding layer 404). FIG. 11 also includes a corresponding top plan view 1110 of the example coil.

In comparison to the narrow magnetic-shielding winding described with respect to FIG. 10, the example implementation shown in FIG. 11 may be referred to as a wide magnetic-shielding winding. The width 602 of the wide magnetic-shielding winding (e.g., the magnetic-shielding-and-enhancement winding 410) is significantly greater than the winding width 610 of the other coil windings 406 (e.g., distance from the innermost winding 406-1 to the outermost winding 406-2). For example, the width 602 of the wide magnetic-shielding winding may be more than double the winding width 610 of the other coil windings 406. In particular, the width of the magnetic-shielding-and-enhancement winding 410 is increased toward the center of the coil to push the field inward toward the center of the coil. Accordingly, the magnetic-shielding-and-enhancement winding 410 is not centered under the other windings 406. Rather, the opening 408 is reduced and an outer edge 1102 of the magnetic-shielding-and-enhancement winding 410 remains proximate (in the x- and y-directions) to the outermost winding 406-3 (similar to the implementations described above with respect to FIGS. 4 and 6-10.

The wide magnetic-shielding winding provides significant shielding to electronics that are placed on the bottom side of the coil (e.g., behind the magnetic-shielding-and-enhancement winding 410). The wide magnetic-shielding winding can also be used as a center-tap, which enables the magnetic-shielding-and-enhancement winding 410 to be used as a ground plane for the electronics. Further, the wide magnetic-shielding winding can reduce the overall winding inductance, which in turn can increase the self-resonant frequency. The additional area (e.g., area 1104) between the innermost winding 406-1 and an inner edge 1106 of the second winding layer 404 (e.g., the magnetic-shielding-and-enhancement winding 410) provides a clean area for vias that can be used for simple access to the ground plane. In one example, the wide magnetic-shielding winding can be incorporated into a 4-layer board, where two layers include the first and second winding layers 402 and 404 and the remaining two layers are used for electronics placement and routing. In some implementations, the magnetic-shielding winding can optionally be duplicated on an inner layer and tied together with stitching vias for more ground access to the center shielding winding.

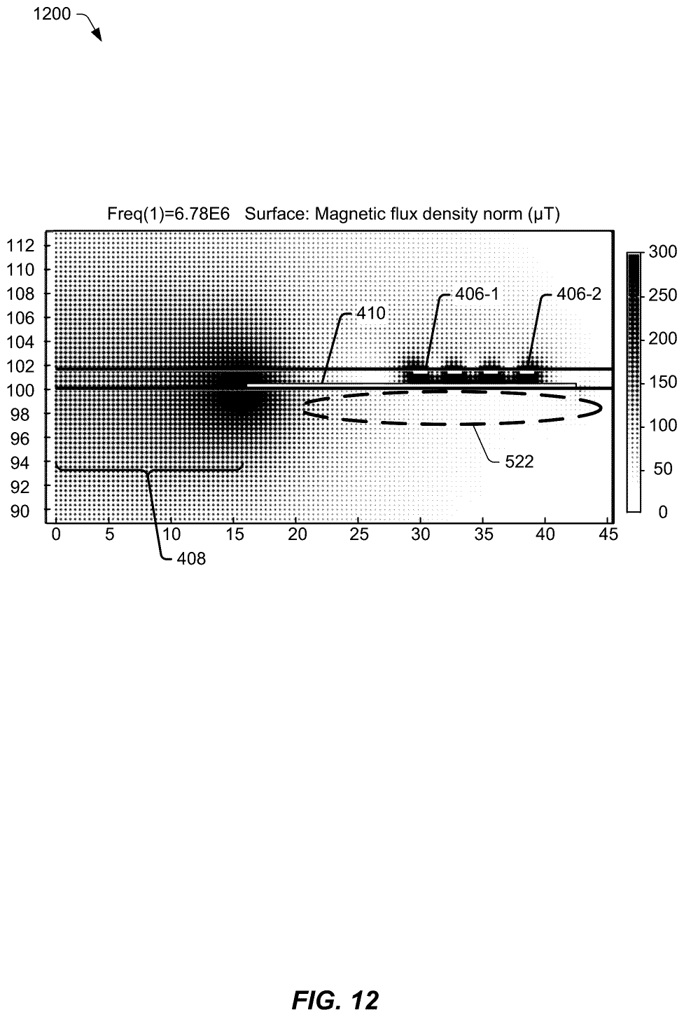

FIG. 12 illustrates a simulation of the surface magnetic flux density of the coil from FIG. 11. Notice the greater width of the magnetic-shielding-and-enhancement winding 410 in comparison to the width of coil windings (from the innermost winding 406-1 to the outermost winding 406-2) results in the surface flux density being pushed substantially toward the center of the coil (e.g., toward the opening 408). Also, the flux density in a region (e.g., region 522) underneath the coil windings 406 (and underneath the magnetic-shielding-and-enhancement winding 410) is substantially less, and the extent of the region of lower flux density is greater, in comparison to the region 522 shown in FIG. 5B, which corresponds to the narrow magnetic-shielding winding described with respect to FIG. 10. For example, an average magnitude of the h-field z-component underneath the windings 406 (e.g., in region 522, from 25 mm to 45 mm (x-axis)) is approximately zero T. Accordingly, by implementing the shield in this way, the average magnitude of the h-field z-component is significantly reduced.

Although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. A wireless-power-transfer unit comprising:
a coil wound to form an opening, the coil including:
a first winding layer in an xy-plane and having a plurality of windings that include at least an innermost winding and an outermost winding, the innermost winding disposed between the opening and the outermost winding; and
a second winding layer stacked in a z-direction with the first winding layer and having a magnetic-shielding-and-enhancement winding, the magnetic-shielding-and-enhancement winding:
being electrically connected to at least one winding of the plurality of windings in the first winding layer;
including first and second opposing surfaces that are normal to the z-direction, the first surface directly facing the first winding layer; and
configured to shield one or more electronics disposed proximate to the second surface.

2. The wireless-power-transfer unit of claim 1, wherein the magnetic-shielding-and-enhancement winding is a last winding of the plurality of windings.

3. The wireless-power-transfer unit of claim 1, wherein the magnetic-shielding-and-enhancement winding is a first winding of the plurality of windings.

4. The wireless-power-transfer unit of claim 1, wherein the magnetic-shielding-and-enhancement winding is a center winding of the plurality of windings.

5. The wireless-power-transfer unit of claim 1, wherein the magnetic-shielding-and-enhancement winding is configured to reduce localized multiplicative effects of aggregate fields generated by the plurality of windings in the first winding layer.

6. The wireless-power-transfer unit of claim 1, further comprising a ferrite layer, wherein the magnetic-shielding-and-enhancement winding is between the ferrite layer and the first winding layer.

7. The wireless-power-transfer unit of claim 1, further comprising a discrete capacitor disposed within the magnetic-shielding-and-enhancement winding.

8. The wireless-power-transfer unit of claim 1, wherein:
the magnetic-shielding-and-enhancement winding includes an inner edge adjacent to the opening and an opposing outer edge proximate to the outermost winding in the first winding layer; and
the magnetic-shielding-and-enhancement winding has a first width defined from the inner edge to the outer edge; and
the plurality of windings in the first winding layer having a second width defined from the innermost winding to the outermost winding.

9. The wireless-power-transfer unit of claim 8, wherein the first width of the magnetic-shielding-and-enhancement winding is substantially equal to the second width in the plurality of windings.

10. The wireless-power-transfer unit of claim 8, wherein the first width of the magnetic-shielding-and-enhancement winding is substantially greater than the second width of the plurality of windings in the first winding layer.

11. The wireless-power-transfer unit of claim 10, wherein the first width is more than double the second width.

12. The wireless-power-transfer unit of claim 10, wherein the first width of the magnetic-shielding-and-enhancement winding is selected to control a self-resonant frequency of the coil.

13. The wireless-power-transfer unit of claim 1, wherein the magnetic-shielding-and-enhancement winding is configured to provide a ground plane for the one or more electronics.

14. The wireless-power-transfer unit of claim 1, wherein the magnetic-shielding-and-enhancement winding is formed by one or more patterns that balance a capacitance between the magnetic-shielding-and-enhancement winding and each of the plurality of windings in the first winding layer.

15. The wireless-power-transfer unit of claim 14, wherein the one or more patterns include a plurality of patches connected together by a connection line in the second winding layer.

16. The wireless-power-transfer unit of claim 15, wherein a respective patch of the plurality of patches is configured to provide magnetic shielding for electronics disposed on an opposing side of the respective patch from the plurality of windings in the first winding layer.

17. The wireless-power-transfer unit of claim 14, wherein the one or more patterns include at least one of a zigzag pattern or a looping pattern.

18. The wireless-power-transfer unit of claim 14, wherein:
the magnetic-shielding-and-enhancement winding includes an inner edge adjacent to the opening and an opposing outer edge proximate to the outermost winding in the first winding layer;
the one or more patterns include a plurality of sections of the magnetic-shielding-and-enhancement winding each having a reduced width;
the reduced width is less than a winding width defined from the innermost winding to the outermost winding; and
one or more of the sections connects two patches of the magnetic-shielding-and-enhancement winding that have a patch width greater than the winding width.

19. The wireless-power-transfer unit of claim 1, further comprising a third winding layer, wherein:
the first winding layer is disposed between the second winding layer and the third winding layer; and
the second winding layer and the third winding layer are layers of the magnetic-shielding-and-enhancement winding.

20. The wireless-power-transfer unit of claim 19, wherein the second winding layer is connected to the third winding layer to form a single winding on opposing sides of the plurality of windings that provides magnetic shielding on both of the opposing sides of the plurality of windings.

21. The wireless-power-transfer unit of claim 19, wherein the second winding layer and the third winding layer are separate windings that individually shield the plurality of windings.

22. The wireless-power-transfer unit of claim 1, wherein a distance between the first winding layer and the second winding layer is set according to a self-resonant frequency of the coil.

23. The wireless-power-transfer unit of claim 1, wherein a width of the magnetic-shielding-and-enhancement winding is set according to a self-resonant frequency of the coil.

24. A wireless-power-transfer unit comprising:
a coil wound to form an opening, the coil including:
a first winding layer in an xy-plane and having a plurality of windings that include at least an innermost winding and an outermost winding, the innermost winding disposed between the opening and the outermost winding; and
a second winding layer stacked in a z-direction with the first winding layer and having a magnetic-shielding-and-enhancement winding, the magnetic-shielding-and-enhancement winding:
being electrically connected to at least one winding of the plurality of windings in the first winding layer;
defining at least one turn of a plurality of turns of the coil, the plurality of turns of the coil including the plurality of windings in the first winding layer; and
being wider than the plurality of windings in the first winding layer.
